(19) United States
(12) Patent Application Publication
(10) Pub. No.: US 2003/0200152 A1
(43) Pub. Date: Oct. 23, 2003

(54) Wireless shopping system and method

(75) Inventor: Sandeep M. Divekar, San Jose, CA (US)

Correspondence Address: BAKER & MCKENZIE, 805 THIRD AVENUE, NEW YORK, NY, 10022, US

(73) Assignee: Computer Associates Think, Inc., Islandia, NY

(21) Appl. No.: 10/126,755

(22) Filed: Apr. 19, 2002

(51) Int. Cl. G06F 17/60

(52) U.S. Cl. 705/26

(57) ABSTRACT

System and method that enables a user to shop for one or more items by comparing the items with similar items using a portable wireless communication device.

### CROSS-REFERENCE TO RELATED APPLICATIONS

The present application claims benefit of provisional application No. 60/284,480 filed Apr. 18, 2001.

### FIELD

The present application relates to a wireless shopping system and method and, more particularly, to a system and method for enabling a user to shop for items after comparing the items to similar items using a portable wireless communication device.

### BACKGROUND INFORMATION

Bar code scanners read Universal Product Codes (“UPCs”). There are a variety of bar code scanners available in the marketplace, such as counter-top bar code scanners, slot bar code scanners, triggered and non-triggered laser bar code scanners, wand bar code scanners, slot badge bar code scanners, charge coupled device bar code scanners, radio bar code scanners, and industrial bar code scanners.

UPCs originated with an organization called the Uniform Code Council (“UCC”). A manufacturer applies to the UCC for permission to enter the UPC system. The manufacturer pays an annual fee for the privilege. In return, the UCC issues the manufacturer a six-digit manufacturer identification number and provides guidelines on how to use the number. The manufacturer identification number can be seen in any standard 12-digit UPC code. A UPC symbol printed, for instance, on a package has two parts: the machine-readable bar code; and the human-readable 12-digit UPC number. The manufacturer identification number is the first six digits of the UPC number and the next five digits are the item number. A person employed by the manufacturer is responsible for assigning item numbers to products, making sure the same code is not used on more than one product and retiring codes as products are removed from the product line. In general, every item the manufacturer sells, as well as every size package and every repackaging of the item, needs a different item code.

The last digit of the UPC code is called a check digit. This digit lets a bar code scanner determine if it scanned the number correctly or not. The check digit is calculated according to a formula from the other eleven digits. Each time the scanner scans an item, a processor performs the calculation. If the calculated check digit is different from the check digit the bar code scanner reads, the processor knows that something went wrong and the item needs to be rescanned.

Further, the first digit of a manufacturer identification number is referred to as the number system character. Different number system characters mean different things. For example, 0 is used for zero-suppressed bar code numbers, 1 is reserved, 2 is used for random-weight items such as fruits, vegetables and meats, 3 is used for pharmaceuticals, 4 is used by retailers for in-store marking, 5 is used for coupons, 6 is a standard UPC number, 7 is a standard UPC number, and 8 and 9 are reserved.

Price information is not encoded in a bar code. When a bar code scanner, for instance, at a checkout line, scans an item, the cash register sends the UPC number to the store's central point of sale (“POS”) computer to look up the UPC number. The central computer sends back the actual price of the item. This approach allows the store to change the price whenever the store wants, for example, to reflect sale prices.

Some bar code scanners allow for customer home shopping. Shoppers can point such bar code scanners at the bar code on an advertisement associated with an item, in a catalog or displayed on a screen that they wish to purchase, then press a button on the bar code scanner. The item is automatically added to an electronic shopping list that is stored in the memory of the bar code scanner. Items can be removed from the list by scanning the bar code on the item they wish to remove, press a delete button and the item is erased from the electronic shopping list. The bar code scanner can also have a lock-out function to prevent others from adding and/or deleting items accidentally. After the bar codes associated with the items are scanned to build the electronic shopping list, the bar code scanner is placed in a cradle attached to a personal computer serial port and the order can be sent to the appropriate merchant. An electronic serial number built into the scanner authenticates the order to protect the buyer and the seller. Such bar code scanners are used at home, but can also be used in a store, and are commonly used as described above for list-making and gift-registry applications.

Other portable bar code scanners are connected to systems so that a customer pick ups a bar code scanner when entering a store and uses the scanner to scan and tally the purchases while shopping. When the customer has concluded the shopping, the customer returns the scanner to the store where the customer receives an automatically dispensed bar coded ticket. The customer presents the ticket to an express checkout station where the cashier scans the ticket and accepts any coupons. The customer then pays the cashier.

Bar code scanners have also been incorporated into personal digital assistants for electronic shopping. These devices can be used to scan bar codes on items, from catalogs or from advertisements producing an electronic shopping list.

There is a need, however, for a portable wireless communication device including a bar code scanner that provides users information about a scanned item and also information about items similar to the scanned item. Thus, users can either purchase the scanned item or one of the similar items at a store or remotely from a merchant using the communication device.

### SUMMARY OF THE INVENTION

An aspect of the present disclosure provides for a method for wireless comparison shopping using a wireless device. The method includes acquiring first item data associated with a first item according to bar code data scanned by the wireless device, generating search data for searching for one or more items similar to the first item based upon data associated with the first item data, acquiring item data associated with the one or more similar items using the search data, and transmitting the first item data and the item data for the one or more similar items to the wireless device, at least a portion of the first item data and at least a portion of the item data associated with the one or more similar items being viewable on a display of the wireless device.

Another aspect of the present disclosure provides for a method for comparing information regarding a first item and a second item using a wireless device. The method includes retrieving first item data associated with the first item and second item data associated with the second item from a memory unit according to bar code data scanned by the wireless device, comparing at least a portion of the first item data and at least a portion of the second item data for determining at least one difference between the first item data and the second item data, and transmitting at least one of the first item data, the second item data and data indicative of the at least one difference to the wireless device.

A further aspect of the present application provides for a method for locating a plurality of sellers. The method includes receiving bar code data and data indicating a location of a wireless device from the wireless device, retrieving first item data associated with a first item from a memory unit according to the bar code data scanned with the wireless device, generating search data for searching the memory unit according to the first item data and the data indicating the location of the wireless device, searching the memory unit for second item data corresponding to a second item using the search data;

retrieving the second item data from the memory unit, if the second item data is located in the memory unit, and transmitting the first item data and the second item data to the wireless device, at least a portion of the first item data and at least a portion of the second item data being viewable on a display of the wireless device.

### BRIEF DESCRIPTION OF THE DRAWINGS

FIG. 1 illustrates an exemplary embodiment of a wireless shopping system of the present disclosure;

FIG. 2 illustrates a portable wireless communication device of the present disclosure;

FIG. 3 illustrates an exemplary data block of a data record used by the systems of the present disclosure;

FIG. 4 illustrates an exemplary flow diagram of an alternative embodiment for providing scanned items data and similar item data to a user of the system of the present disclosure;

FIG. 5 illustrates a flow diagram of an alternative embodiment for providing scanned item data and similar item data to a user of the system of the present disclosure;

FIG. 6 illustrates an exemplary embodiment for providing scanned item data and similar item data to a user according to the present disclosure;

FIG. 7a illustrates an exemplary embodiment of a display of a portable wireless communication device of the present disclosure; and

FIG. 7b illustrates an exemplary embodiment of a display of a portable wireless communication device of the present disclosure.

### DETAILED DESCRIPTION

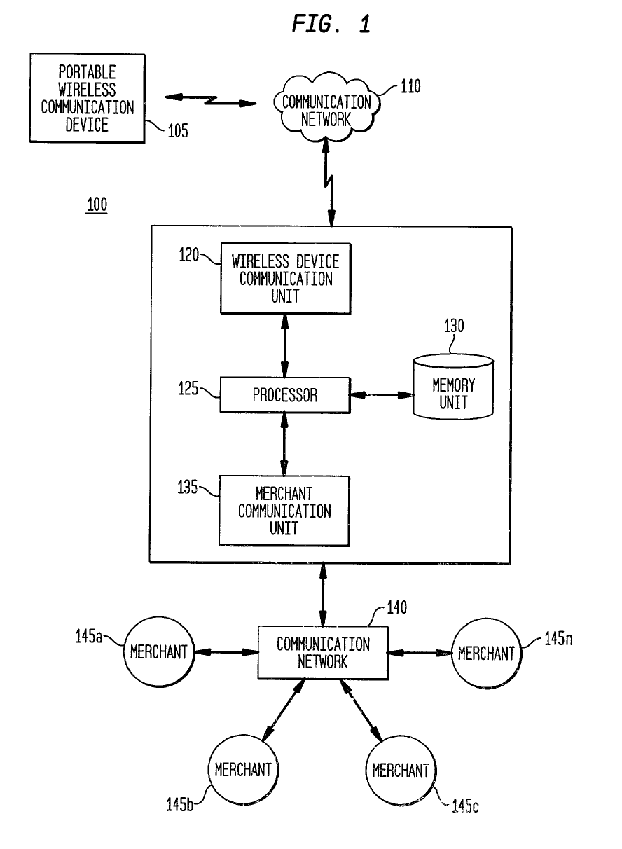

FIG. 1 illustrates an exemplary wireless shopping system 100 that includes one or more portable wireless communication devices 105, a communication network 110, a controller 115 and a communication network 140. The portable wireless communication device 105 are capable of transmitting data to and receiving data from wireless device communication unit 120 of the service provider controller 115 via the communication network 110. The communication network 110 may be any type of wireless communication network, such as a cellular network and the portable wireless communication device 105 may be any type of wireless communication device capable of communicating with network 110, for example, a cellular telephone. However, other communication networks (e.g. LAN, WAN, digital wireless networks) can be utilized and compatible portable wireless communication devices can be used as well, such as personal digital assistants and personal computers. The service provider controller 115 also includes processor 125, memory unit 130 and merchant communication unit 135. The merchant communication unit 135 transmits data to and receives data from various merchants 145a . . . 145n via communication network 140. Communication network 140 can be a wireless communication network, for example, a cellular network, or a landline communication network (such as a LAN, POTS, etc.). Alternatively, wireless communication network 110 and wireless communication network 140 can be the same communication network. Further, memory unit 130 can include various types of memory storage devices, for example, one or more databases, relational or otherwise.

The components of FIG. 1 may be implemented through hardware, software, and/or firmware. The number of components in wireless shopping system 100 is not limited to what is illustrated.

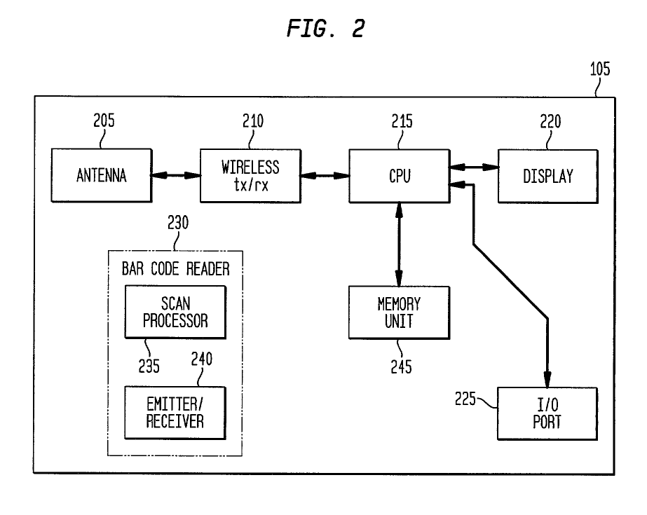

FIG. 2 illustrates an exemplary embodiment of portable wireless communication device 105 of the present application. Portable wireless communication device 105 includes an antenna 205 coupled to wireless transmitter/receiver 210 for transmitting data to and receiving data from wireless device communication unit 120. Antenna 205 can be an internal or external antenna and transceiver/receiver 210 can be a single component or two components, a receiver coupled to antenna 205 and a transmitter coupled to antenna 205. Portable wireless communication device 105 also includes CPU 215, display 220, memory unit 245 and input/output port 225. Input/output port 225 receives requests from individuals. For instance, input/output port 225 receives requests input from a data entry device, such as a keypad or touch screen and stylus, to generate data regarding scanned items and similar items. In an alternative embodiment, input/output port 225 is integrated into CPU 215.

In addition, portable wireless communication device 105 has integrated therein bar code reader 230. Bar code reader 230 is includes a scan processor 235 and emitter/receiver 240. In an alternative embodiment of the present application, bar code reader 230 is external to the portable wireless communication device 105 and operates in conjunction therewith. Bar code reader 230 is operable for scanning a UPC bar code or a bar code created according to the European Article Numbering (“EAN”) system on an item, on the packaging of an item, on a label, sign or the like associated with the item or in an advertisement illustrating the item or a description thereof. The bar code, however, can also be located on a display screen, for example, on a personal computer display screen, or in a catalog and can be scanned by bar code reader 230. The scanned bar code corresponds to a series of predetermined numbers and is converted into the series of predetermined numbers by software stored, for example, in memory unit 245 and executed by scan processor 235. The software can be stored and executed by other components as well located within either portable wireless communication device 105 or located external thereto, for example, in service provider controller 115 (seen in FIG. 1).

The components of FIG. 2 may be implemented through hardware, software, and/or firmware. The number of components in wireless communication device 105 is not limited to what is illustrated.

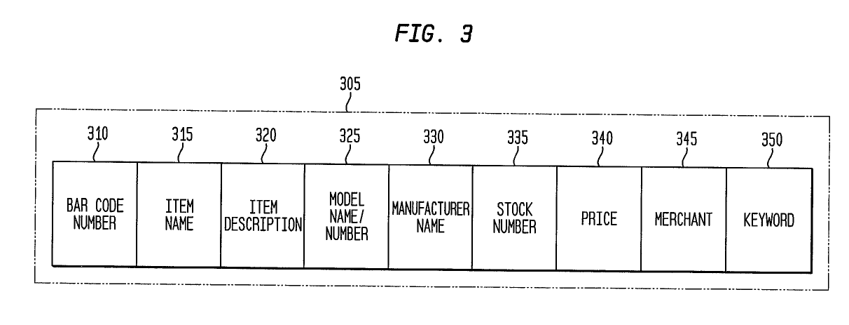

FIG. 3 illustrates an exemplary embodiment of a data record or data entry 305 of the present application. Data record 305 is stored in, for example, memory unit 130 of the service provider controller 115 and relates to a scanned item, for example, a particular compact disc mini-stereo system. In an exemplary embodiment, the data record 305 includes various fields for storing data. For example, the data record can include bar code number field 310, item name field 315 that stores data indicating the name of the item, item description field 320 that stores data describing the item, model name/number field 325 that stores data providing the model name and/or number of the item, manufacturer name field 330 that stores data indicating the manufacturer of the item, stock number field 335 that provides a stock number for the item, price field 340 that stores data indicating a price, for instance, the retail price, for the item, merchant field 345 that stores data indicating one or more merchants selling the item and keyword field 350 that stores one or more keywords used for searching for data stored in memory unit 130.

In an exemplary embodiment of the present application, data stored in keyword field 350 is manually input into service provider controller 115 by an individual using an input device, not shown in FIG. 1, and stored in the relevant data record 305 according to the item pertaining to the keywords. Keywords can be data indicating categories associated with an item. For example, if an item being purchased is a compact disc mini-stereo system, some of the keywords entered and stored in keyword field 350 of the respective data record 305 could be “stereo”, “mini”, “compact disc” and “CD”. The keywords are used by processor 125 when searching for other data records stored in memory unit 130 associated with other vendors or merchants. The data is stored in a similar manner and the fields are searched.

Further, bar code number field 310 store a predetermined bar code number associated with a respective item. Processor 125 attempts to match a scanned bar code to a predetermined bar code number stored in a respective bar code number field 310. When the bar code numbers match, processor 125 can retrieve the respective data record 305 associated with the predetermined bar code number from memory unit 130. In an exemplary embodiment, data in memory unit 130 is created according to data in one or more inventory databases and/or memory unit 130 is associated with one or more inventory databases.

The following exemplary embodiments of the present application are explained with reference to a compact disc (“CD”) mini-stereo system as the item. Data, however, regarding other items can obviously be stored, processed and transmitted by wireless shopping system 100.

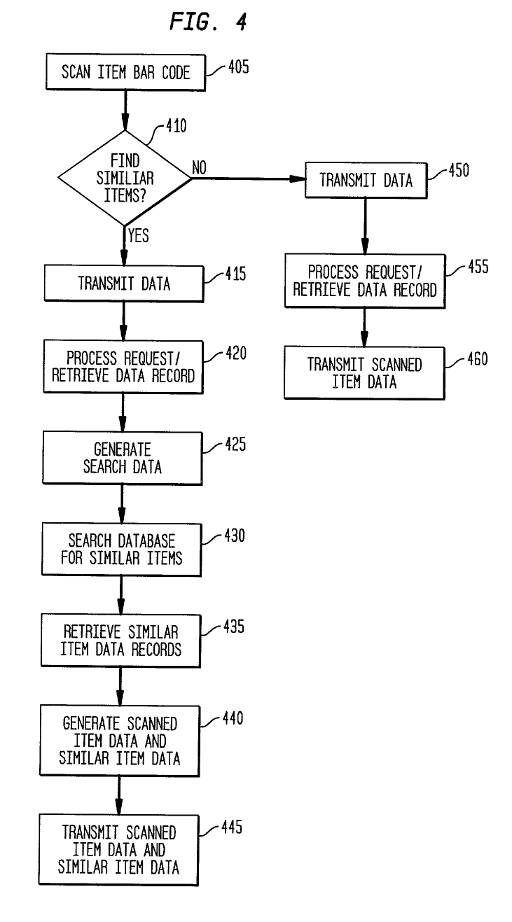

FIG. 4 illustrates an exemplary embodiment for providing scanned item data and similar item data to a user of portable wireless communication device 105. The exemplary embodiment illustrated by the flowchart of FIG. 4 pertains to a user who can simultaneously receive data about a scanned item and data about one or more items similar to the scanned item at the user's portable wireless communication device 105. The scanned item refers to the item associated with the bar code scanned by bar code reader 230.

A user scans a bar code, for example, on the packaging of a CD mini-stereo system using emitter/receiver 240 of bar code reader 230 incorporated within portable wireless communication device 105, (step 405). The scanned bar code is converted into a predetermined bar code number by scan processor 235 and scan processor 235 transmits the scanned bar code number to CPU 215. The bar code number is stored in memory unit 245. The user then receives a prompt on display 220 transmitted by CPU 215 inquiring whether the user also desires data regarding one or more other items, for example, other CD mini-stereo systems, that are similar to the specific CD mini-stereo system that was scanned, (step 410). Using I/O port 225, if the user wants similar item data, wireless transceiver/receiver 210 of portable wireless communication device 105 transmits the request along with the scanned bar code number for the scanned item to the wireless device communication unit 120 (step 415). In an exemplary embodiment of the present disclosure, the scanned bar code is converted by scan processor 235 into a series of numbers forming the scanned bar code number which is transmitted to wireless device communication unit 120.

Wireless device communication unit 120 receives the request and the bar code number and processor 125 coupled thereto processes the user's request to retrieve scanned item data and similar item data. A data record 305 for the scanned item is retrieved from memory unit 130 by matching the scanned bar code to predetermined bar code numbers stored in memory unit 130 (step 420). Once data record 305 associated with the scanned item is retrieved, the processor 125 then generates search data for searching one or more databases for similar items. (step 425). The search data is generated by processor 125 using keywords stored in keyword field 350 and/or data stored in item description field 320 of the respective data record 305. For example, an SQL search is performed. After generating search data, processor 125 searches memory unit 130, for example, by performing an SQL search query, for other items similar to the scanned item—the scanned CD mini-stereo system—using the generated search data (step 430). If processor 125 locates similar items, processor 125 retrieves the respective one or more data records stored in memory unit 130, (step 435). In an alternative embodiment, processor 125 can search merchant Internet web sites, external databases and/or memory unit 130 for similar items using the generated search data or query.

For example, the user may have scanned the packaging of a CD mini-stereo system manufactured by X company and operable for holding six CDs. As a result of the user indicating that the user would also like information about similar items, processor 125 generates search data (or a query) according to the specific scanned item and retrieves data records for similar CD mini-stereo systems having the capability of holding multiple CDs, but manufactured by the same or different companies. Alternatively, the processor 125 can retrieve data records associated with CD mini-stereo systems having the capability of holding six CDs. The retrieved data record for the scanned item and the one or more retrieved data records for the similar items are generated into scanned item data and similar item data, respectively, by processor 125 for transmission and display on display 220 of portable wireless communication device 105, in 440. The scanned item data and similar item data, if any, are then transmitted to wireless transceiver/receiver 210 of the user's portable wireless communication device 105 via antenna 205, (step 445). For example, the transmitted scanned item data and similar item data can include data indicating the item name, item description, model name/number, manufacturer name, stock number, the retail price and the names of other merchants selling the item along with their corresponding prices. The user can view a menu displayed on portable wireless communication device 105 and select the scanned item and/or similar items the user wishes to see more information about. Upon the user selecting one or more items, the received scanned item data and/or similar item data is output by CPU 215 to display 220 so that the user can view the scanned item data and/or similar item data on display 220 of portable wireless communication device 105. The specified item data and similar item data can be stored in memory unit 245.

Using portable wireless communication device 105, the user can purchase either the scanned item or a similar item after viewing and comparing the scanned item data and similar item data. In an exemplary embodiment of the present disclosure, the user has previously entered and stored contact information, such as name, address and telephone numbers, shipping information and credit card information in memory unit 130 of service provider controller 115 either through an Internet web site using wireless communication device 105 or via mail or e-mail. The user can transmit the previously entered information or enter and transmit new information. In an exemplary embodiment, the information is encrypted and stored in memory unit 130 and is retrieved with a pass code and/or a digital certificate. In an alternative embodiment, user information is entered by a user for each transaction, as opposed to being stored in memory unit 130.

A user request to purchase an item is transmitted to service provider controller 115 and, if entered, the user's contact, shipping and credit card information or, if not entered, the user's contact, shipping and credit card information is retrieved from memory unit 130. Processor 125 and merchant communication unit 135 connect to the respective purchasing system of one of the merchants 145a . . . 145n. The request and contact, shipping and credit card information is transmitted to the respective purchasing system for processing. Once the purchasing system has verified the credit card information and approved the transaction, confirmation indicia, for example, a confirmation number, and shipping information is transmitted to portable wireless communication device 105. Also, if there is an option for merchandise pick-up at a physical location, such information is also transmitted to portable wireless communication device 105. Otherwise, the scanned item or similar item is delivered to the user according to the shipping information stored in memory unit 130.

Returning to step 410 in FIG. 4, if the user indicates that the user does not want to receive similar item data at portable wireless communication device 105, but rather data only about the specific scanned item, wireless transceiver/receiver 210 transmits data indicating the user request and the bar code number for the scanned item to wireless device communication unit 120 of service provider 115 via communication network 110 (step 450). Processor 125 processes the user request and retrieves the respective data record 305 for the scanned item from memory unit 130 having a predetermined bar code number stored in bar code number field 310 matching the bar code number transmitted by wireless transceiver/receiver 210, (step 455). The scanned item data is then transmitted to portable wireless communication device 105, in (step 460). In an exemplary embodiment of the present application, the transmitted scanned item data includes data indicating the item name, item description, model name/number, manufacturer name, stock number, the retail price, and merchants selling the item along with corresponding prices. As described above, the user can then purchase the scanned item from one of the indicated merchants or the merchant at which the item was scanned.

Once the user receives the scanned item data and/or similar item data, the user can transmit from portable wireless communication device 105 the scanned item data and/or similar item data to another portable wireless communication device 105. The user can also input a message to be attached to the transmission. For example, after the user scans the bar code for a CD mini-stereo system and receives information about the stereo system, and similar item data, if requested, the user may desire to transmit all or at least a portion of the information to another individual's portable wireless communication device 105 for assistance in making a purchase decision. The user can enter a message to that effect into the user's portable wireless communication device and attach the message to the transmission of the information to the other individual. Thereafter, the other individual can provide feedback information to the user, for example, either by calling the user's portable wireless communication device 105 or transmitting a data message to portable wireless communication device 105.

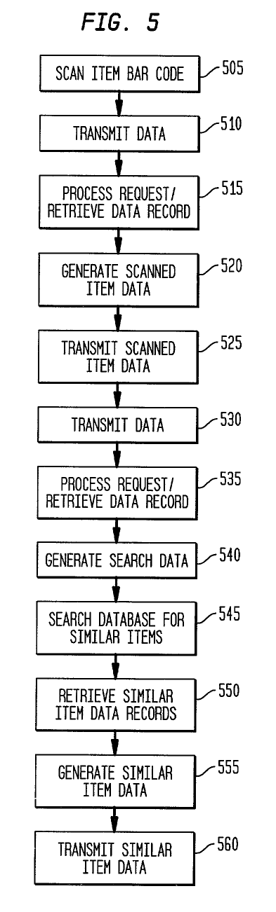

FIG. 5 illustrates another exemplary embodiment for providing scanned item data and similar item data to a user. The exemplary embodiment illustrated by the flowchart of FIG. 5 pertains to a user requesting the receipt of similar item data after first receiving and viewing scanned item data on display 220 of portable wireless communication device 105.

A user scans a bar code, for example, on the packaging of a CD mini-stereo system using emitter/receiver 240 of bar code reader 230 incorporated within portable wireless communication device 105, (sep 505). The scanned bar code is converted into a scanned bar code number by scan processor 235 and scan processor 235 transmits the scanned bar code number to CPU 215. The code number is stored in memory unit 245. Wireless transceiver/receiver 210 of portable wireless communication device 105 also transmits the user's request to wireless device communication unit 120 (step 510). In an exemplary embodiment, the scanned bar code is converted by scan processor 235 into a series of numbers forming the scanned bar code number which is transmitted to wireless device communication unit 120.

Wireless device communication unit 120 receives the request and the bard code number and processor 125 processes the user's request. A data record 305 is retrieved from memory unit 130 by matching the scanned bar code to a predetermined bar code number stored in memory unit 130 (step 515). Wireless device communication unit 120 of processor 125 thereafter transmits scanned item data retrieved by processor 125 from the retrieved data record 305 associated with the scanned bar code number to portable wireless communication device 105 so that the user can view the scanned item data on display 220, (steps 515 and 520). In an exemplary embodiment, the transmitted scanned item data includes data indicating the item name, item description, model name/number, manufacturer name, stock number, the retail price, and names of merchants selling the item along with corresponding prices.

After viewing the scanned item data on display 220, the user can input a request that instructs the processor 125 to retrieve from memory unit 130 one or more data records 305 for items similar to the scanned item represented by the scanned bar code number (step 530) Alternatively, the scanned bar code number is not transmitted with the request, as the bar code number is stored in memory unit 130 by processor 125 at the time of the first request. For example, the user presses a designated key on portable wireless communication device 105 in order to transmit the data. Processor 125 thereafter processes the user's new request. Specifically, the processor 125 retrieves the scanned item data associated with the scanned bar code as described above (step 535) and then generates search data for searching one or more databases for similar items (step 540). In an exemplary embodiment, search data is generated by processor 125 using keywords stored in keyword field 350 and/or data stored in item description field 320 of the respective data record 305. For example, SQL searches are performed. After generating search data, processor 125 searches memory unit 130 for other items similar to the scanned item—the scanned CD mini-stereo system—using the generated search data, (step 545), e.g., by performing an SQL search query. If processor 125 locates similar items, processor 125 retrieves the respective one or more data records stored in memory unit 130, (step 550).

For example, the user may have scanned the packaging of a CD mini-stereo system manufactured by X company and operable for holding six CDs. As a result of the user indicating that the user would also like information about similar items, processor 125 generates search data (or a query) according to the specific scanned item and retrieves data records for CD mini-stereo systems having the capability of holding multiple CDs, but manufactured by the same or different companies. Alternatively, the processor 125 retrieves data records for CD mini-stereo systems having the capability of holding six CDs. Similar item data is generated by processor 125 from the retrieved data records of the one or more similar items for transmission and display on display 220 of portable wireless communication device 105, in 550. The similar item data, if any, is then transmitted to wireless transceiver/receiver 210 of portable wireless communication device 105 via antenna 205, (step 560). For example, the transmitted similar item data can include data indicating the item name, item description, model name/number, manufacturer name, stock number, suggested price, and the name of other merchants selling the item along with their corresponding prices. The user can view a menu displayed on portable wireless communication device 105 and select the scanned item and/or similar items the user wishes to see more information about. Upon the user selecting one or more items, the received similar item data is output by CPU 215 to display 220 so that the user can view the scanned item data and similar item data on display 220 of portable wireless communication device 105.

The process of purchasing the scanned item or a similar item is the same as discussed above with reference to FIG. 4 and is, therefore, not again discussed with reference to FIG. 5.

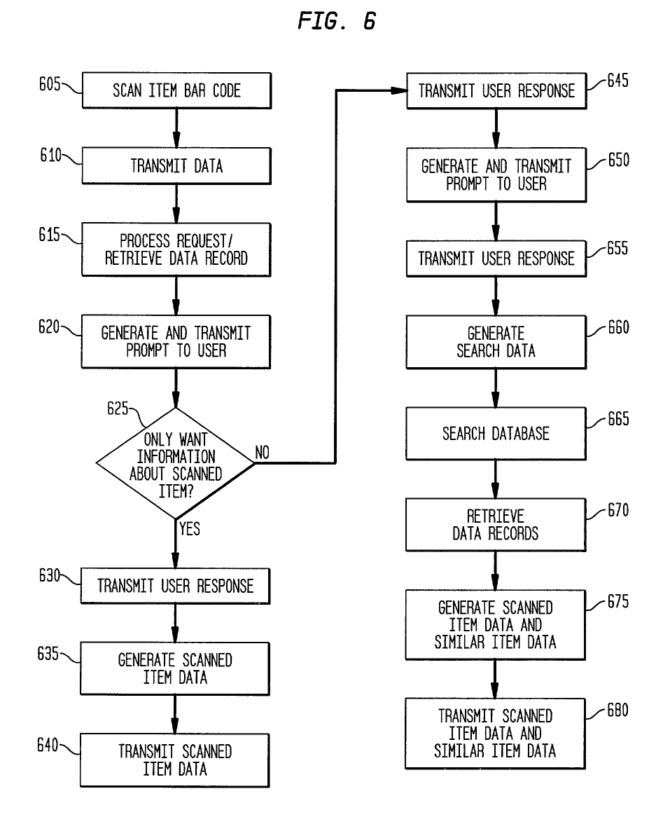

FIG. 6 illustrates a further exemplary embodiment for providing scanned item data and similar item data to a user. The exemplary embodiment illustrated by the flowchart of FIG. 6 allows a user to control parameters used when searching for similar item data in memory unit 130. Steps 605 to 615 shown in FIG. 6 are the same as steps 505 to 515 shown in FIG. 5 and described herein and, therefore, are not again described with reference to FIG. 6.

After processor 125 retrieves the data record 305 for the specific scanned item from memory unit 130, (step 615), the processor 125 generates and transmits to the portable wireless communication device 105 a prompt asking the user whether the user only wants to receive data regarding the scanned item, in steps 620 and 625). If the user only desires scanned item data, the user can respond by pressing a designated key on portable wireless communication device 105 indicating “yes”, (step 630). Upon receiving the “yes” response from the user, processor 125 retrieves scanned item data from the respective data record stored in memory unit 130, (step 635), and transmits to portable wireless communication device 105 the scanned item data, (steps 640). In an exemplary embodiment, the transmitted scanned item data includes data indicating the item name, item description, model name/number, manufacturer name, stock number, the retail price and the names of other merchants selling the item along with their corresponding prices.

If in step 625 the user desires both scanned item data and similar item data, the user can respond by pressing a designated key on portable wireless communication device 105 indicating “no” (step 645). Processor 125 receives the user request via wireless device communication unit 120 and generates and transmits another prompt to portable wireless communication device 105 described below (step 650). Alternatively, upon the user indicating that the user wants both the scanned item data and similar item data, (step 625). The processor 125 does not prompt the user again, but rather generates search data, searches memory unit 130, retrieves one or more data records 305 from memory unit 130, generates similar item data from the retrieved one or more data records and transmits the scanned item data and similar item data to portable wireless communication device 105 as described above with reference to FIG. 4.

The prompt transmitted to portable wireless communication device 105, in steps 650 and 655, asks the user one or more questions that alter the search parameters for similar items. For example, processor 125 prompts the user whether the user desires data about similar items manufactured by the same manufacturer as the scanned item, but different models, and/or data about similar items manufactured by different manufacturers. One or more additional prompts or other prompts can be transmitted to portable wireless communication device 105.

In response to the one or more questions, the user can respond by pressing a designated key on portable wireless communication device 105 (step 655). According to the user's response (or responses), the processor 125 generates search data(or a query) (step 660). In an exemplary embodiment, the search data is generated in the following way if, for example, the user response indicated that the user desired data about similar items manufactured by the same manufacturer as the scanned item. Processor 125 generates search data as discussed above with reference to FIGS. 4 and 5, however, the search data may also include a parameter indicating that the one or more data records 305 for the similar items should have the same manufacturer name in manufacturer field 330 of data record 305 as the scanned item. After processor 125 generates the search data (or query) (step 660), the processor 125 searches through data records stored in, for example, memory unit 130 for similar items, (step 665). If processor 125 locates similar items, processor 125 retrieves the e data records from memory unit 130, (step 670). From the one or more retrieved data records for the similar items, as well as from the retrieved data record for the scanned item, similar item data and scanned item data is generated by processor 125, (step 675).

The scanned item data and similar item data is then transmitted to portable wireless communication device 105 (step 680). In an exemplary embodiment, the transmitted scanned item data and similar item data include data indicating the item name, item description, model name/number, manufacturer name, stock number, the retail price, and the names of other merchants selling the item along with their corresponding prices. The user can view a menu including data indicating the scanned item and similar items and select one or more items the user wishes to see more information about. Upon the user selecting one or more items, the received item data is output by CPU 215 to display 220 so that the user can view the scanned item data and similar item data on display 220 of portable wireless communication device 105.

The process of purchasing the scanned item or a similar item is the same as discussed above with reference to FIG. 4 and is, therefore, not again discussed with reference to FIG. 6.

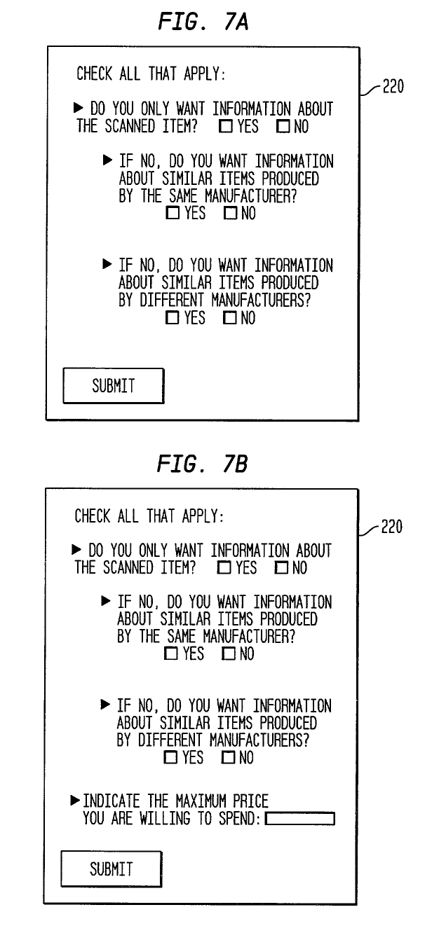

FIG. 7a illustrates an exemplary view shown on display 220 of portable wireless communication device 105. Portable wireless communication device 105 is used with a stylus allowing a user to make selections and write characters, for instance, directly on display 220. The use of such a stylus is well known in the art, as styluses are commonly used with personal digital assistants. As can be seen in FIG. 7a, the information shown on display 220 relates to the prompt set forth in step 625 of FIG. 6. Specifically, the user is prompted by processor 125 whether the user only wants information about the scanned item, as shown in FIG. 7a. If the user desires only information about the scanned item, the user would check the “yes” box and click on the submit button with the stylus. On the other hand, if the user also wants information about similar items, the user would first check the “no” box with the stylus and then check the appropriate box or boxes indicating whether the user wants data about similar items manufactured by the same manufacturer and/or different manufacturers. The user would thereafter click on the submit button with the stylus.

The use of a stylus to input information into portable wireless communication device 105 is purely exemplary and, therefore, various other techniques can be utilized to input information into portable wireless communication device 105.

Further, additional prompts can be generated and transmitted by processor 125 to portable wireless communication device 105 and depicted on display 220. In an exemplary embodiment, user responses to such prompts would control the breadth of the search for data about similar items stored in memory unit 130. For example, FIG. 7b illustrates an additional prompt asking the user to input the maximum price the user is willing to spend for similar items. By the user inputting a maximum price, for example, by writing the price in a predetermined area on display 220 with a stylus, the search for similar item data stored in memory unit 130 is conducted accordingly. In particular, processor 125 generates search data (or a query) and searches for data records stored in memory unit 130 wherein price data stored in price field 340 of the data record 305 is equal to or less than the inputted maximum price.

In each of the exemplary embodiments of the present application, the user can also retrieve additional information from one or more third parties using portable wireless communication device 105. The additional information may include general or specific product safety information, such as from Consumer Reports, articles and consumer feedback. For instance, upon a user viewing scanned item data and/or similar item data on display 220 of portable wireless communication device 105, the user can access such additional information regarding the respective scanned item and/or similar item. The user can input commands or select commands, for example, from a menu, on portable wireless communication device 105 indicating that the user desires particular additional information from a third party regarding an item. The user commands are thereafter transmitted to processor 125 of service provider controller 115. Processor 125 retrieves the requested additional information from the respective third party and transmits the information to portable wireless communication device 105. The user can then view the additional information on display 220.

In another exemplary embodiment, a user can scan a specific item with bar code reader 230 of wireless communication device 105. After the user scans the specific item, processor 125 of service provider controller 115 retrieves the data record for the scanned item, searches memory unit 130 and retrieves one or more data records for similar items as discussed above with reference to FIGS. 4, 5 and 6. Processor 125 compares the data record for the scanned item and the one or more data records for the similar items. In particular, software stored in memory unit 130 and executed by processor 125 compares data stored in at least one field of the data record for the scanned item with data stored in the corresponding field of the data record for a similar item. As a result, the software generates data indicating at least one difference between the data records. For example, the user may have scanned a CD mini-stereo system manufactured by x company and processor 125 may have retrieved a similar data record for a CD mini-stereo system manufactured by Y company. Upon the software comparing the manufacturer name fields 330 of the data records for the scanned item and the similar item, the software would generate data indicating a difference—the similar item is manufactured by Y company and the scanned item is manufactured by X company. Processor 125 transmits the data indicating one or more differences to portable wireless communication device 105. Processor 125 can transmit the scanned item data and similar item data before, after or concurrently with the transmission of the data indicating the one or more differences. The difference data can be automatically displayed on display 220 of portable wireless communication device 105 or the user can instruct portable wireless communication device 105 to display the data upon the user, for example, pressing a predetermined key.

In an alternative embodiment, a user can scan two specific items with bar code reader 230. Data indicating the respective bar code numbers is transmitted via wireless transceiver/receiver 210 and processor 125 of service provider controller 115 retrieves the respective data records for the scanned items as discussed above with reference to FIGS. 4, 5 and 6. Processor 125 compares the data records for the scanned items. In particular, software stored in memory unit 130 and executed by processor 125 compares data stored in at least one field of the data record for the scanned item with data stored in the corresponding field of the data record for the other scanned item. As a result, the software generates data indicating at least one difference between the data records. Processor 125 transmits the data indicating one or more differences to portable wireless communication device 105. In an alternative embodiment, more than two scanned items are scanned by bar code reader 230 and the respective data records are compared by processor 125. Processor 125 then transmits the difference data indicating one or more differences between the scanned items to portable wireless communication device 105.

In a further exemplary embodiment of the present disclosure, the user can transmit a bid, or purchase offer, to a respective merchant for the purchase of a scanned item and/or similar item. For example, the user receives at portable wireless communication device 105 scanned item data including at least one merchant price for the scanned item. The user can submit a purchase offer to the merchant by inputting and transmitting a price the user is willing to pay for the scanned item using portable wireless communication device 105. The purchase offer is received by the merchant and the merchant can either accept or deny the user's purchase offer by transmitting a merchant response to portable wireless communication device 105. In an alternative embodiment, the user can transmit the purchase offer for a scanned item to a plurality of merchants. Such that one or more merchants can transmit a merchant response to portable wireless communication device 105.

In another exemplary embodiment of the present application, processor 125 receives from portable wireless communication device 105 data indicating a bar code number for a scanned item and data indicating the physical location of portable wireless communication device 105. The data indicating the physical location of portable wireless communication device 105 can be generated by a global positioning system circuit located within portable wireless communication device 105, by utilizing user profile information stored in memory unit 130 or by any other manner for determining the location of a device or person. Processor 125 retrieves a data record for the scanned item from memory unit 130 and generates search data from the retrieved data record as described above with reference to FIGS. 4, 5 and 6. Processor 125, however, also utilizes the received data indicating the location of portable wireless communication device 105 to generate the search data. As a result, processor 125 searches and retrieves from memory unit 130 one or more data records for similar items having merchant data stored in merchant field 345 that satisfy predetermined location parameters. For example, only data records for similar items having stored therein data about merchants having a store location located within a predetermined distance, say 5 miles, from portable wireless communication device 105 are retrieved by processor 105 for transmission to the user. In an alternative embodiment, processor 125 retrieves data records for similar items offered for sale by merchants through the Internet, over telephone and/or having a store location located within a predetermined distance from portable wireless communication device 105.

In a still further exemplary embodiment of the present application, portable wireless communication device 105 can be used to input delivery name, date and address information upon purchasing one or more scanned items and/or one or more similar items as described above with reference to FIGS. 4, 5 and 6. As a result, the user can shop for and purchase items with portable wireless communication device 105 and schedule future delivery dates with respective merchants for those items to be shipped to other individuals. Applications include holiday shopping, such as Christmas, or any other event that has or will occur. For example, a user can go to a merchant's store and scan with bar code reader 230 of portable wireless communication device 105 one or more scanned items and acquire data about those scanned items as discussed above with reference to FIGS. 4, 5 and 6. Further, the user can receive data about similar items as discussed above with reference to FIGS. 4, 5 and 6. The user can thereafter purchase one or more items with portable wireless communication device 105, or in person at the merchant, and enter data about one or more recipients names, addresses and the dates for deliveries into portable wireless communication device 105. As would be appreciated by a person of ordinary skill in the art, any manner of entering new data and selecting previously entered data into portable wireless communication device 105 can be utilized. Accordingly, the individuals will receive directly from the respective merchants the items. In an alternative embodiment, the user via portable wireless communication device 105 can also input greeting information to be transmitted to the individuals or enclosed with the specific and/or similar items sent to the individuals by the respective merchants.

The embodiments described above are illustrative examples of the present application and it should not be construed that the present application is limited to these particular embodiments. Various changes and modifications may be effected by one skilled in the art without departing from the spirit or scope of the invention as defined in the appended claims.

What is claimed is:

1. A method for wireless comparison shopping using a wireless device, the method comprising:
acquiring first item data associated with a first item according to bar code data scanned by the wireless device;
generating search data for searching for one or more items similar to the first item based upon data associated with the first item data;
acquiring item data associated with the one or more similar items using the search data; and
transmitting the first item data and the item data for the one or more similar items to the wireless device, at least a portion of the first item data and at least a portion of the item data associated with the one or more similar items being viewable on a display of the wireless device.

2. The method for wireless comparison shopping using a wireless device as set forth in claim 1, further comprising:
comparing at least a portion of the first item data and at least a portion of the item data associated with the one or more similar items for determining at least one difference between the first item data and the item data associated with the one or more similar items; and
transmitting data indicative of the at least one difference to the wireless device.

3. The method for wireless comparison shopping using a wireless device as set forth in claim 1, wherein
the wireless device is one of a cellular communication device, a personal digital assistant and a personal computer.

4. The method for wireless comparison shopping using a wireless device as set forth in claim 1, wherein
the first item data includes a first price and a first seller and
the item data associated with the one or more similar items includes a second price and a second seller.

5. The method for wireless comparison shopping using a wireless device as set forth in claim 4, further comprising:
receiving a purchase offer for at least one of the first item and the one or more similar item from the wireless device;
transmitting the purchase offer to at least one of the first seller and the second seller; and
receiving a reply from at least one of the first seller and the second seller, the reply being responsive to the purchase offer.

6. A method for comparing information regarding a first item and a second item using a wireless device, the method comprising:
retrieving first item data associated with the first item and second item data associated with the second item from a memory unit according to bar code data scanned by the wireless device;
comparing at least a portion of the first item data and at least a portion of the second item data for determining at least one difference between the first item data and the second item data; and
transmitting at least one of the first item data, the second item data and data indicative of the at least one difference to the wireless device.

7. The method for comparing information regarding a first item and a second item using a wireless device as set forth in claim 6, wherein
the wireless device is one of a cellular communication device, personal digital assistant and a personal computer.

8. A method for locating a plurality of sellers, the method comprising:
receiving bar code data and data indicating a location of a wireless device from the wireless device;
retrieving first item data associated with a first item from a memory unit according to the bar code data scanned with the wireless device;
generating search data for searching the memory unit according to the first item data and the data indicating the location of the wireless device;
searching the memory unit for second item data corresponding to a second item using the search data;
retrieving the second item data from the memory unit, if the second item data is located in the memory unit; and
transmitting the first item data and the second item data to the wireless device, at least a portion of the first item data and at least a portion of the second item data being viewable on a display of the wireless device.—

9. The method for locating a plurality of sellers as set forth in claim 8, wherein
a seller of the first item and a seller of the second item are within a predetermined distance from the wireless device.
